(19) United States
(12) Patent Application Publication
(10) Pub. No.: US 2011/0176002 A1
(43) Pub. Date: Jul. 21, 2011

(54) Camera Apparatus for Use in a Motor Vehicle

(76) Inventor: Henryk Bury, Lohne (DE)

(21) Appl. No.: 12/753,370

(22) Filed: Apr. 2, 2010

(30) Foreign Application Priority Data
Apr. 23, 2009 (DE) 10 2009 018 517.8

(51) Int. Cl. H04N 7/18

(52) U.S. Cl. 348/148; 348/E07.085

(57) ABSTRACT

A camera apparatus for use in a motor vehicle which has an interior space, a housing (7) intended for holding a camera sensor (15) and capable of being fitted for viewing through a windscreen (1) in a suitable alignment towards the road being travelled on by the motor vehicle, and a display device (26) for displaying picture elements acquired by the camera sensor (15), a simple positioning of the camera for various types of vehicle results from the fact that the housing (7) is designed in at least two parts with a fastening part (6, 6′, 6″) having the bearing surface (13), and with a camera part (14) supporting the camera sensor (15), that the camera part (14) can be connected to the fastening part (6, 6′, 6″) in a fixed relative position, and that the fastening part (6, 6′, 6″) is designed for specific vehicles with reference to the alignment of its bearing surface (13) such that the camera sensor (15) has the suitable alignment after the connection of the camera part (14) to the fastening part (6, 6′, 6″).

The invention relates to a camera apparatus for use in a motor vehicle which has an interior space, a housing intended for holding a camera sensor and capable of being fitted for viewing through a windscreen in a suitable alignment towards the road being travelled on by the motor vehicle, and a display device for displaying picture elements acquired by the camera sensor.

Such a camera apparatus is known from EP 1 383 098 B1. Here, the housing with the camera sensor is mounted as an attachment on the dashboard of the motor vehicle. The arrangement serves for detecting traffic signs. Located in a central console is the display device which is set up to reproduce the symbols corresponding to the detected traffic signs by providing it with a library, stored in a memory, of traffic signs which come into consideration. The display device is permanently installed in the motor vehicle and connected to the tachometer of the motor vehicle for the purpose of comparison of the maximum permissible speed with the instantaneous driving speed. Since the housing with the camera sensor must be connected to the display device via an invisibly fitted cable, the result is that the camera can be positioned only directly on the top side of the dashboard of the motor vehicle, and so there is a problem in positioning the camera optimally. Moreover, the camera housing must be of small design so that neither the driver nor the front seat passenger perceives it as interfering with the view onto the road.

A proposal to position the camera on the rear side of the interior rear view mirror of the motor vehicle leads to the disadvantage that readjusting the interior rear view mirror also entails an adjustment of the field of view of the camera. Moreover, the image quality is impaired by reflections of the obliquely running windscreen, which is arranged remote from the camera sensor.

It is the object of the present invention to enable a better positioning of the camera, in particular for a retrospective installation of the camera apparatus.

According to the invention, this object is achieved with a camera apparatus of the type mentioned at the beginning which is characterized in that the housing is designed in at least two parts with a fastening part having the bearing surface, and with a camera part supporting the camera sensor, in that the camera part can be connected to the fastening part in a fixed relative position, and in that the fastening part is designed for specific vehicles with reference to the alignment of its bearing surface such that the camera sensor has the suitable alignment after the connection of the camera part to the fastening part.

The inventive camera apparatus therefore enables the camera sensor to be fitted in the immediate vicinity of the windscreen at a location where the housing holding the camera sensor does not impede the view of the occupants onto the road. Such a location is found, for example, on the upper edge of the windscreen, preferably behind the interior rear view mirror of the motor vehicle which, as is known, is arranged in the middle of the width and in the upper region of the windscreen. The display device can be arranged at a suitable site in the interior space of the motor vehicle within the angle of view of the driver.

In a preferred embodiment of the invention, the housing is designed with a transparent bearing surface which can be fastened on the inside of a windscreen of the motor vehicle, the fastening preferably being performed by adhesion. The problem arises here that the inclination of the windscreen is specific to the vehicle, and thus depends on the type of the vehicle and on the respective vehicle model. Sports vehicles and ones shaped from aerodynamic points of view in this case have a windscreen running very obliquely in relation to the vertical, whereas commercial vehicles, such as buses, minibuses, delivery vans, etc. are, however, fitted with steeply running windscreens. According to the invention, use is made for the respective type of vehicle of a specific fastening part which is fitted on the windscreen, preferably by being bonded on in the form of a frame. By adapting the inclination of the bearing surface to the inclination of the windscreen, it is ensured that the section of the fastening part on which the camera part is preferably fastened by being latched on is suitably aligned so as to ensure the suitable alignment of the camera sensor after the fitting of the camera part on the fastening part.

The camera sensor fitted according to the invention can be allotted a further usefulness by virtue of the fact that there is connected in the housing to the camera sensor a video image memory which as FIFO memory stores video images over a prescribed period and overwrites them continuously with new video images. It is ensured in this way that, for example, the video images of the last 30 minutes which have been recorded by the camera sensor are stored in the memory, and this can, for example, be important for clarifying the origin of a traffic accident. In the case when the recording is required, further recording by the camera sensor must be terminated. To this end, the recording of new video images can be switched off by a switch, it being possible for the switch to be actuated manually or controlled by a sensor. Particular consideration is given as sensor to a crash sensor such as is used to trigger airbags.

The inventively provided display device is preferably positioned to be spatially remote from the housing, the image content of the camera sensor being provided with an interface for transmission to the display device. The transmission of the image content can be performed in this case via a cable or in a wireless fashion when the interface is designed for wireless transmission and the display device has a receiver for the wirelessly transmitted signals.

In a preferred embodiment of the invention, the evaluation electronics for the image content acquired by the camera sensor is arranged in the housing such that the evaluated picture elements can be identified at the camera sensor by means of the evaluation electronics and, particularly for the wireless transmission, even signals which characterize the evaluated picture elements are used. In this case, there is preferably present in the display device a memory for stored symbols by means of which the picture elements acquired by the camera sensor can be selectively displayed on the display device. The evaluation at the camera sensor actually renders it possible for the first time to make regular wireless transmissions, since the wireless transmission of the picture elements recorded by the camera sensor to the display device would require the enabling of a substantial transmission speed which cannot be implemented in practice with cost-effective equipment. Since the evaluation electronics for the picture elements acquired by the camera sensor, which are to be displayed, is itself arranged in the housing on the camera sensor, the transmission to the display device need include only a coded signal which characterizes the type of the picture element acquired by the camera sensor, and so can be retrieved by the display device from the memory of the stored symbols. All short-range transmission methods, such as in accordance with the Bluetooth Standard, for example, are suitable for the wireless transmission of the signal characterizing the acquired picture element.

Of course, it is possible, particularly given the production of a cable connection between the camera sensor and the display device, to reproduce the camera signals directly on the display device, or to undertake the evaluation of the camera signals in the display device.

In a preferred embodiment of the invention, the display device has a fastening device for subsequent installation in the interior space of the motor vehicle. This can, for example, be a fastening foot which can be bonded on in the region of the dashboard, and onto which the display device can be latched. Also possible is a fastening foot which can be bonded onto a glass pane, it being possible to perform adhesion over a suitable region of the windscreen or a fixed part of a side pane of the motor vehicle. Again, the fastening foot can be fastened, in particular on a glass pane, by means of a suction cup, as a result of which the adhesion can be omitted.

In a further preferred embodiment of the invention, the camera apparatus also comprises a satellite positioning module and a receiving antenna therefor. When traffic signs are detected with the camera sensor in a preferred embodiment of the invention, the through the relatively accurate permanent determination of the position of the motor vehicle which is possible with the aid of the position data, the detection of the traffic signs can be supported by virtue of the fact that permanently erected traffic signs are stored in a memory of the display device for specific positions, that is to say for specific stretches of a road, and also enable a display of a symbol on the display device whenever an optical detection of the traffic sign by the camera sensor has been disturbed or completely prevented, for example by a lorry masking the view onto the traffic sign while being overtaken at this instant. The satellite position module, which can be formed by a GPS mouse, is preferably arranged on or in the housing of the camera sensor. In this case, an information item stored in a memory relating to traffic signs or the like cooperates with the satellite position module in order to carry out plausibility control of a (not reliably) detected or, given no detection of the traffic sign, to replace a traffic sign detection with the stored information, possibly with an appropriate instruction.

When detecting a traffic sign, it is the acquisition of permissible maximum speeds indicated by the traffic signs which is most important. In this case, the display device can include an evaluation device for determining the instantaneous speed of the motor vehicle from the received satellite position data such that a comparison device can be used to compare the instantaneous speed of the motor vehicle with the detected maximum permissible speed. If the maximum permissible speed is exceeded by the determined instantaneous speed, or is exceeded by a prescribed span, the display device preferably outputs an optical and/or acoustic warning signal in order to caution the driver to observe a speed adapted to the maximum permissible speed.

The inventive camera arrangement can be used, furthermore, for the purpose of detecting pedestrians who are located in the driving direction in front of the motor vehicle, and to output an appropriate warning. It is preferred in this case that the detection of the pedestrians is correlated with a determination of speed from the satellite position data, in order, for example, to suppress a warning about pedestrians when a vehicle is stationary. Moreover, by evaluating the size of the detected pedestrians it is possible to establish a relationship between an estimate of the distance of the pedestrians from the motor vehicle and the determined speed of the motor vehicle, in Order to enable a reliable warning of danger.

The invention will be explained in more detail below with the aid of exemplary embodiments illustrated in the drawing, in which:

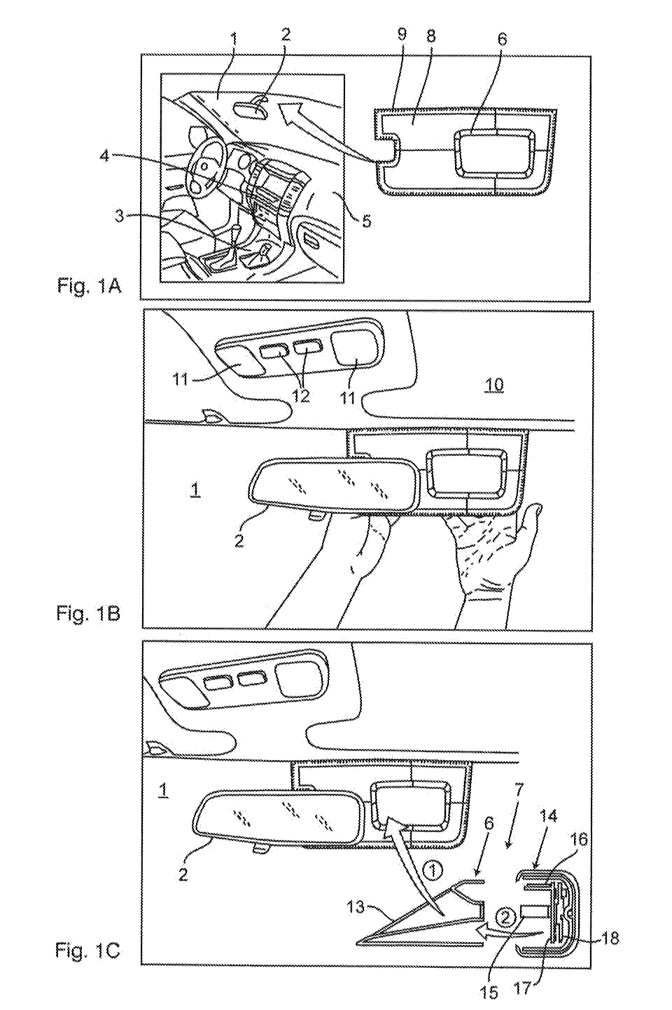

FIGS. 1a to c show the fitting of a housing in accordance with a first embodiment of the invention on a windscreen of a motor vehicle,

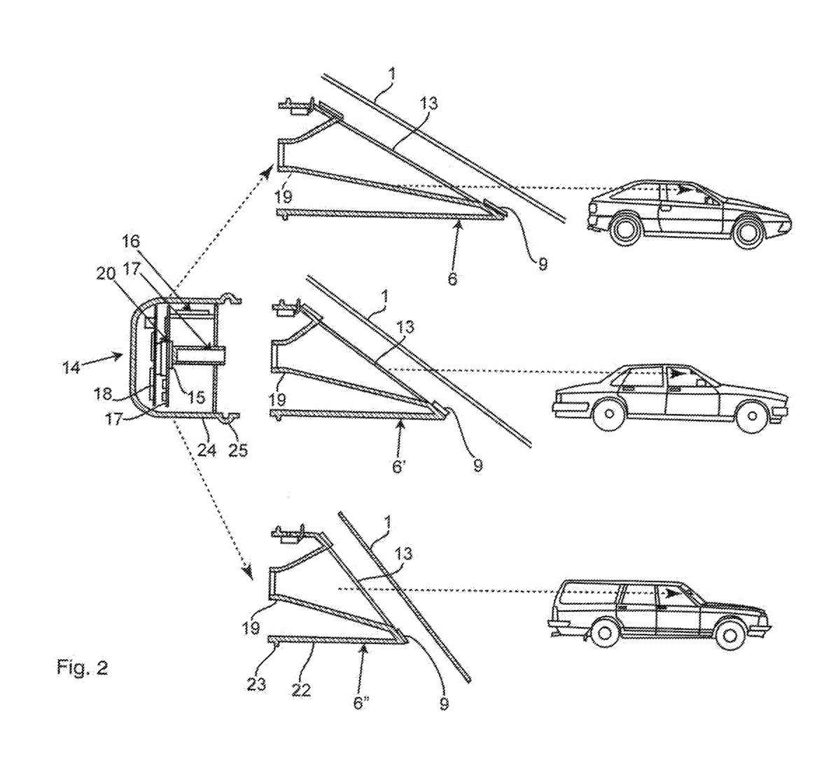

FIG. 2 shows variants of the design of the housing, consisting of a fastening part and a camera part, for various inclinations of the windscreen with the use of fastening parts specific to the vehicle,

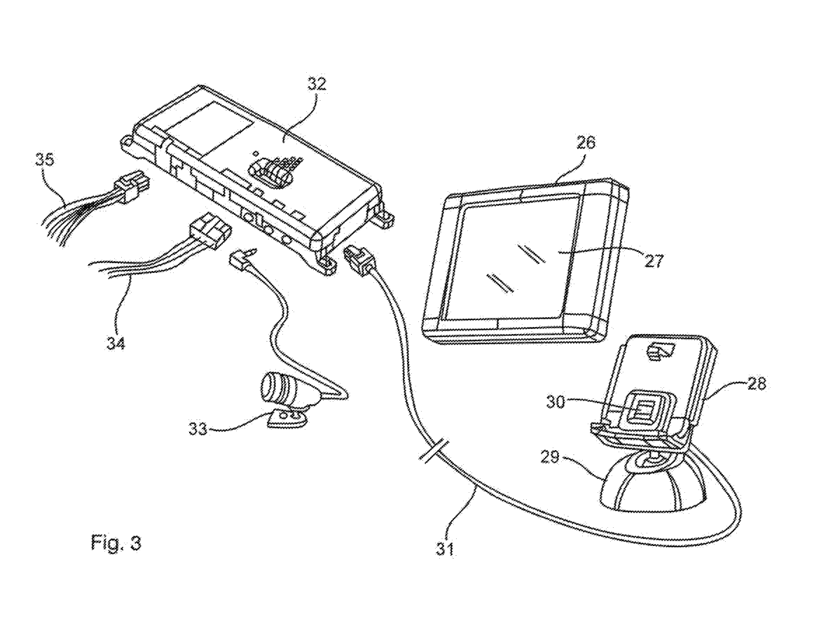

FIG. 3 shows a schematic illustration of an inventive display device which is, at the same time, a display device for a telephone hands-free device of the motor vehicle, and

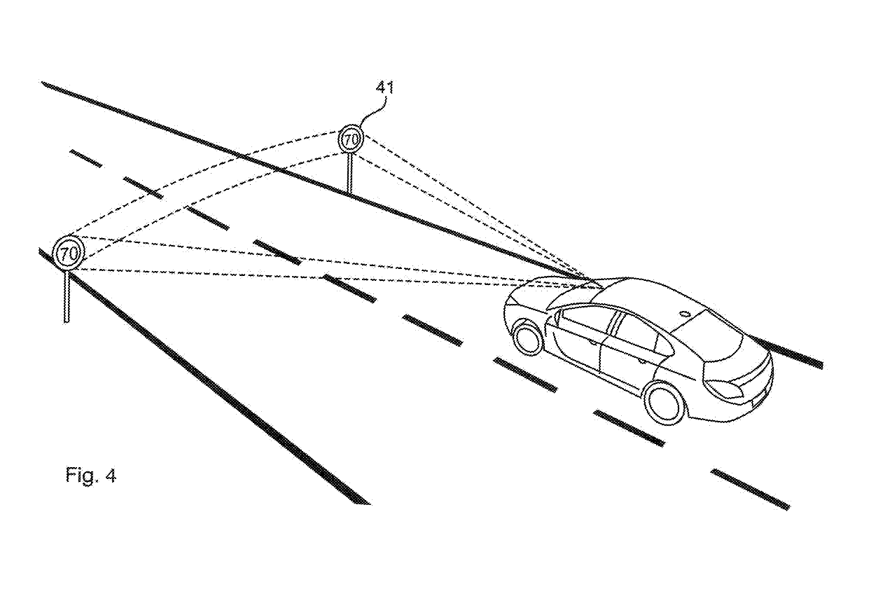

FIG. 4 shows a diagrammatic illustration of the use of the inventive camera apparatus for detecting traffic signs.

FIG. 1a) shows diagrammatically a perspective view of an interior space of a motor vehicle with a windscreen 1, an interior rear view mirror 2 fastened on the windscreen, a central console 3 with a multimedia device 4, the central console projecting into the region of a dashboard 5.

As FIG. 1a) illustrates, a fastening part 6 of a bipartite housing 7 (FIG. 1c)) is provided with a flexible fastening plate 8 for adhesively fastening on the windscreen 1 in the region of the interior rear view mirror 2. To this end, the fastening plate 8 has a peripheral outer edge which is formed by an adhesive strip 9 and forms a closed adhesive frame with which the fastening plate 8 can be bonded onto the windscreen 1 on the upper edge thereof, as is illustrated in FIGS. 1b) and 1c).

Located above the windscreen is a vehicle roof 10 in which conventional interior lights 11 and associated switches 12 are fastened.

It is to be seen from FIG. 1c) that the fastening part 6 bears against the windscreen 1 with a flat, transparent bearing surface 13. The fastening part 6 is designed to be open to the side averted from the windscreen 1, and can be augmented towards the housing 7 by a camera part 14 which can be detachably connected to the fastening part 6. In its interior, the camera part 14 has a camera sensor 15 and printed circuit boards 16, 17, 18, on which a camera electronics, an evaluation electronics, a satellite navigation antenna and a satellite navigation module are arranged.

FIG. 2 shows variants of fastening parts 6 which are designed, in a fashion specific to the vehicle, for different inclinations of the windscreens 1 on various vehicles. Thus, FIG. 2a) illustrates a greatly inclined windscreen 1 for a sports motor vehicle, FIG. 2b) illustrates a windscreen 1 of lesser inclination for a touring limousine, and FIG. 2c) illustrates a relatively steep windscreen 1 for an estate car. Consequently, fastening parts 6, 6′, 6″ are provided whose bearing surfaces 13 have appropriately adapted inclinations. In addition, the fastening parts 6, 6′, 6″ form angular receptacles 19 into which an objective 20 of the camera sensor 15 can be introduced, and is held, in an alignment suitable for observing the road lying in front of the motor vehicle. In addition, the fastening part 6, 6′, 6″ is provided with rearwardly directed housing lugs 22 which have an outwardly directed circumferential annular bead 23 over which it is possible to snap on a housing lug 24 with an inwardly open annular groove 25 of the camera part 14, in order thus to form the complete housing 7.

The housing 7 is preferably fastened without cable connection on the windscreen 1 with an independent power supply (battery), and includes an evaluation electronics with the aid of which objects to be identified which have been recorded by the camera sensor 15 are detected. The evaluation electronics thus determines whether and, if appropriate, which objects to be detected have been received by the camera sensor 15, and generates a corresponding identification signal which can be transmitted to a display device in a wireless fashion with the aid of a transmitter arranged in the housing 7.

FIG. 3 shows an exemplary embodiment of a display device 26 for which use is made of a display unit of a telephone hands-free device. The display device 26 includes a display 27, preferably a liquid crystal display, on which it is possible, owing to the incorporation in the telephone hands-free device, to display telephone data such as telephone books, telephone numbers of accepted or dialled subscribers, etc. The display device 26 can be fastened on a holder 28 which can be mounted in the motor vehicle and, for example, be bonded with the aid of a foot 29 onto the dashboard 5 in the interior space of the motor vehicle. The holder 28 produces an electric connection to the display device 26 via a contact arrangement 30, and can be connected via a cable 31 to a base unit 32 of the hands-free device, which base unit is permanently mounted in the car in a fashion invisible from the interior space. It is also possible to connect to the base unit 32 a microphone 33 fitted at a suitable site in the interior space, and a loudspeaker cable 34 leading to a loudspeaker (not illustrated). A further cable 35, which can be connected to the base unit 32, produces a connection to the vehicle electronics and, for example, transmits a muting signal for a car radio when the playing of the radio program is to be interrupted because of a telephone conversation being conducted. Furthermore, the connection to an ignition signal is produced such that the base unit 32 of the hands-free device can detect whether the ignition of the motor vehicle is switched on or not.

In addition to these functions as display device 26, inside a hands-free device the inventive display device 26 is provided, furthermore, with a receiver for the signals transmitted in a wireless fashion by the camera unit in the housing 7. Moreover, the display device includes a memory (not illustrated), from which it is possible by means of the wirelessly transmitted signals to retrieve symbols for display on the display 27 of the display device 26. In this way, information relating to image content recorded by the camera sensor is successfully transmitted from the camera sensor to the display device 26 without the need to transmit enormous amounts of data of video signals.

FIG. 4 symbolizes the function of the camera sensor for the detection of traffic signs 41. The video images of the camera sensor 15 are evaluated in the evaluation device present in the housing 7 so as to detect that a traffic sign 41 indicating a maximum speed, here “70”, has been detected. The evaluation device therefore generates an appropriate coded signal which is transmitted to the display device 26 in a wireless fashion from the housing 7. In the display device 26, the received coded signal is used to retrieve from a memory a symbol which is reproduced on the display 27 of the display device 26 as traffic sign indicating the maximum speed “70”, such that the driver of the motor vehicle is informed as to which traffic sigh has currently been detected.

When, in addition, a satellite navigation device is provided in the display device 26, the display device 26 can calculate the instantaneous speed of the motor vehicle from the satellite position data and compare it with the maximum permissible speed detected on the basis of the detected traffic sign 41. Via the display device 26, or via the connection of the display device 26 to the base unit 32, an acoustic signal can be transmitted via the loudspeaker cable 34 and reproduced, and/or an optical signal can appear on the display 27 of the display device 26. Of course, it is also possible to conceive of other signal transmitters with the aid of which the driver can be alerted to the fact that he is exceeding the maximum permissible speed, if appropriate by a prescribed speed interval.

The inventive camera arrangement can also have in the housing 7 a memory device with the aid of which the signals of the camera sensor 15 are stored annularly in accordance with the existing storage capacity such that the latest camera images are stored for a predetermined interval and can be used, for example, to clear up the origin of an accident. Further storage should be stopped in the event of an accident. This can be done manually or under sensor control, for example by means of a crash sensor.

1. Camera apparatus for use in a motor vehicle which has an interior space, a housing (7) intended for holding a camera sensor (15) and capable of being fitted for viewing through a windscreen (1) in a suitable alignment towards the road being travelled on by the motor vehicle, and a display device (26) for displaying picture elements acquired by the camera sensor (15), characterized in that the housing (7) is designed in at least two parts with a fastening part (6, 6′, 6″) having the bearing surface (13), and with a camera part (14) supporting the camera sensor (15), in that the camera part (14) can be connected to the fastening part (6, 6′, 6″) in a fixed relative position, arid in that the fastening part (6, 6′, 6″) is designed for specific vehicles with reference to the alignment of its bearing surface (13) such that the camera sensor (15) has the suitable alignment after the connection of the camera part (14) to the fastening part (6, 6′, 6″).

2. Camera apparatus according to claim 1, characterized in that the camera part (14) can be connected in a latching fashion to the fastening part (6, 6′, 6″).

3. Camera apparatus according to claim 1, characterized in that the housing (7) is designed with a transparent bearing surface (13) which can be fastened on the inside of the windscreen (1) of the motor vehicle.

4. Camera apparatus according to claim 1, characterized in that there is connected in the housing (7) to the camera sensor (15) a video image memory which as FIFO memory stores video images over a prescribed period and overwrites them continuously with new video images.

5. Camera apparatus according to claim 4, characterized in that the recording of new video images can be switched off by a switch.

6. Camera apparatus according to claim 5, characterized in that the switch can be actuated manually.

7. Camera apparatus according. to claim 5, characterized in that the switch can be controlled by a crash sensor.

8. Camera apparatus according to claim 1, characterized in that the display device (26) is a display device of a telephone hands-free device.

9. Camera apparatus according to claim 1, characterized in that the display device (26) has a fastening device (28) for subsequent installation in the interior space of the motor vehicle.

10. Camera apparatus according to claim 1, characterized by an evaluation electronics for picture elements acquired by the camera sensor (15).

11. Camera apparatus according to claim 10, characterized in that the evaluation electronics is arranged in the housing (7) and is connected to an interface for transmitting signals identifying the evaluated picture elements to the spatially remote display device (26).

12. Camera apparatus according to claim 11, characterized in that the evaluation electronics in the housing (7) is provided with an interface for the wireless transmission of the image content, and the display device (26) is provided with a receiver for the wirelessly transmitted signals.

13. Camera apparatus according to claim 1, characterized in that it comprises a satellite positioning module and a receiving antenna therefor.

14. Camera apparatus according to claim 13, characterized in that it also has an evaluation device for determining an instantaneous speed from the received satellite position data.

15. Camera apparatus according to claim 10, characterized in that the evaluation electronics is designed at least to detect road sight (41), in particular ones for indicating a maximum permitted speed.

16. Camera apparatus according to claim 14, characterized in that the display device (26) also includes a comparison device for comparing the determined, instantaneous speed with the detected maximum permissible speed.

17. Camera apparatus according to claim 1, characterized in that the evaluation electronics is designed to detect pedestrians in front of the motor vehicle.

18. Camera apparatus according to claim 1, characterized in that the display device (26) is designed to initiate at least one optical and/or acoustic warning signal.
